(19) United States
(12) Patent Application Publication
(10) Pub. No.: US 2009/0037996 A1
(43) Pub. Date: Feb. 5, 2009

(54) Multi-Domain Secure Computer System

(76) Inventor: Peter P. Shiakallis, Chesapeake, VA (US)

Correspondence Address: TROUTMAN SANDERS LLP, 600 PEACHTREE STREET , NE, ATLANTA, GA, 30308, US

(21) Appl. No.: 12/182,913

(22) Filed: Jul. 30, 2008

Related U.S. Application Data
(60) Provisional application No. 60/952,678, filed on Jul. 30, 2007.

(51) Int. Cl. H04L 9/32; G06F 21/06

(52) U.S. Cl. 726/9; 726/35

(57) ABSTRACT

Disclosed is a hardware based secure multi-domain computer system. The system comprises a housing enclosing multiple separate, secure computer devices. The housing is preferably the size of a standard computer tower. It is preferred that at least three computer devices are disposed within the housing. Each of the computer devices operate on significantly less power than a standard computer. Preferably, each computer operates on no more than 50 Watts of power, more preferably on less than 35 Watts of power.

### CROSS-REFERENCE TO RELATED APPLICATION(S)

The present application claims the benefit of U.S. Provisional Patent Application Ser. No. 60/952,678, filed 30 Jul. 2007, and entitled “Hardware-Based Secure Multi-network System,” which is hereby incorporated by reference in its entirety as if fully set forth below.

### TECHNICAL FIELD

The present invention relates generally to the field of computer systems, and more particularly, a multi-domain secure computer system.

### BACKGROUND

Prior designs of multilevel computer systems include the use of complicated mechanical switching mechanisms (see U.S. Pat. No. 6,009,518) or the addition of complex circuitry with relays and microprocessors controlled via automatic teller machine (ATM) styled keypads requiring a personal identification number (PIN) for switching from one network domain to the other by powering down one domain and powering up to another domain. (see U.S. Pat. Nos. 6,389,542, and 6,351,810). These systems result in a total loss of data on a when switching domains, because such switching over includes operating system shutdown and re-boot along with substantial switching time delays. Most of such computer systems share the same central processing units (CPU), random access memory (RAM), universal serial bus (USB) controllers, video memory, floppy drives, and compact disk read only memory (CD-ROM) drives. Therefore, the domain is not sufficiently isolated and secure to meet military and other requirements. Further, prior designs rely on conventional power supplies which render the units unfit for mobile applications.

### BRIEF SUMMARY OF THE INVENTION

The present invention is directed to a hardware based secure multi-domain computer system. The system comprises a housing enclosing multiple separate, secure computer devices. The housing is preferably the size of a standard computer tower. It is preferred that at least three computer devices are disposed within the housing. In other contemplated embodiments, fewer or more than three computer device may be disposed with the housing. Each of the computer devices operate on significantly less power than a standard computer. Preferably each computer operates on no more than 50 Watts of power, more preferably on less than 35 Watts of power.

The housing preferably comprises a single lock and door or a plurality of locks and doors for securing the computer devices within the housing. The doors of the housing provide sufficient space to enable components, such as wireless antennae, to be connected to the computer devices within the enclosed housing.

Each of the computer devices preferably has an individual power supply, separate from the power supplies of the other computer devices. Further, each of the computer devices has a separate compartmentalized domain, that is shielded and separated from the domains of the other computer devices. The system is designed such that each of the three domains can be secure.

The system may further include access control feature such as locks, smart cards, and encryption. The hardware of the system is preferably miniaturized. All of the necessary cards are preferably contained within and built into the system. The system further preferably comprises a plurality of monitors, each monitor corresponding to and in communication with one of the computer devices.

The objective of this invention is to provide a custom-built secure multilevel computer system to provide data security from within and prevent inside unauthorized user access as well as outside unauthorized user access via the Internet or a network. This invention was requested by the Department of Defense, the Pentagon, and other government agencies to be used in critical operating environments for secured and unsecured networks that need to be viewed without delays. These environments require processing of unclassified and classified data instantly and without compromising data security between domains and without powering down and re-booting between domains which results to data loss upon switching between domains contained in the same computer.

The benefits of this technology other than data security include: instant domain switching; reduced footprint; reduced power consumption; reduced heat output; reduced EMF emissions; reduced maintenance and acquisition costs; and reduced operating system costs.

These and other features as well as advantages, which characterize the various preferred embodiments of present invention, will be apparent from a reading of the following detailed description and a review of the associated drawings.

### BRIEF DESCRIPTION OF THE DRAWINGS

FIG. 1 illustrates an exemplary embodiments of a system of the present invention.

FIG. 2 illustrates a block diagram of a processing unit.

FIG. 3 illustrates a front view of processing unit.

FIG. 4 illustrates a back view of a processing unit.

FIG. 5 illustrates a top view of a processing unit.

FIG. 6 illustrate a top view of a processing unit with a top cover removed.

### DETAILED DESCRIPTION OF PREFERRED EMBODIMENTS

Referring now to the drawings, in which like numerals represent like elements, exemplary embodiments of the present invention are herein described.

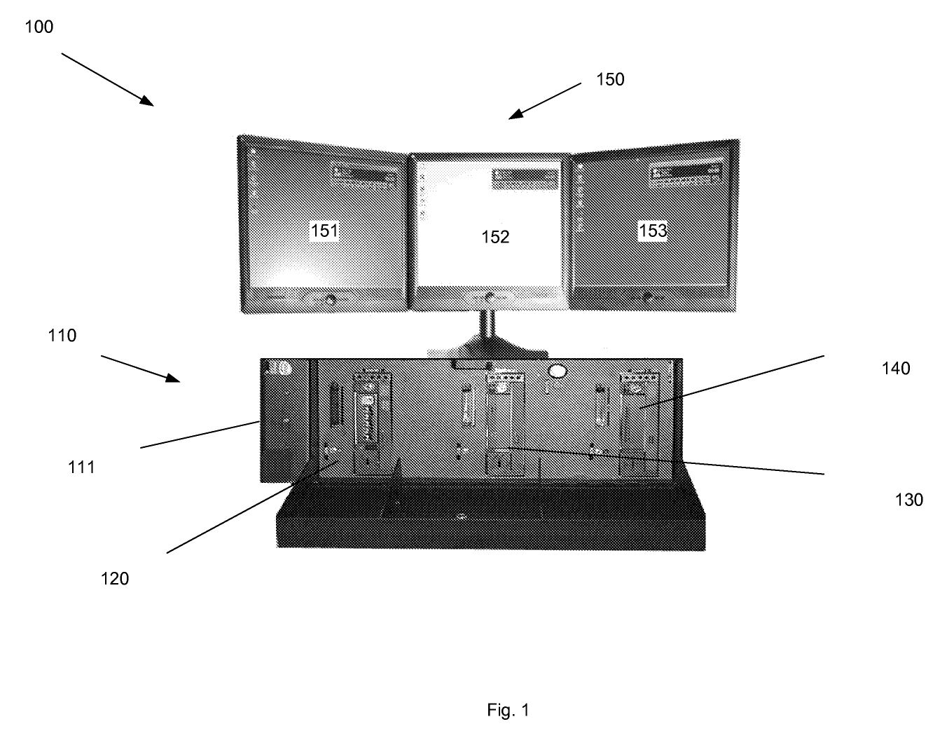

FIG. 1 illustrates an exemplary embodiments of a system 100 of the present invention. The system 100 can comprise a multi-domain processing unit 110 and a monitor array 150. The processing unit 110 can be housed in a case 111. The case 111 can be constructed from lightweight high strength metal, preferably conforming to U.S. military standards for computing devices. Preferably the case 111 is constructed from cast aluminum. The heavy-duty cast iron case 111 is especially designed to accommodate 14 expansion slots instead of the traditional 6 or 8. The case has a low EMF radiation output level and a 350 watt power supply. The case 111 can include front and back doors with security locks for limiting individuals who can access the processing unit. In a contemplated embodiment, the case 111 can be mounted on a standardized (EIA 310-D, IEC 60297 and DIN 41494 SC48D) 19-inch rack.

The processing unit 110 can comprise three or more separate domains. In accordance with an exemplary embodiments, the processing unit can 110 can comprise a first domain 120, a second domain 130, and a third domain 140. At least one of the domains is preferably a secure domain. In an exemplary embodiment, domains 120 and 130 can be secure and domain 140 can be unsecure. Domains 120 and 130 can having differing levels of security depending on the user's requirements and preferences. For example, domain 120 can be secure and domain 130 can be semi-secure.

The monitor array 150 can comprise a plurality of separate monitors. In an exemplary embodiment, the array 150 can comprise a first monitor 151, a second monitor 152, and a third monitor 153. In other embodiments more or fewer monitors can be employed. In a preferred embodiment, each of the monitors 151, 152, and 153 is a 15 inch to 22 inch LCD XVGA monitor. In other embodiments, the different monitor types and sizes can be employed. For example, the monitors 151, 152, and 153 can each be 24 inch plasma monitors. The monitors 151, 152, and 153 are preferably physically coupled to each other and to a stand. For example, the second monitor 152 can be mounted to a stand, and the first and second monitors 151 and 153 can be mounted to either side of the second monitor 152.

Each of the monitors 151, 152, and 153 can simultaneously display the “desktop” of one of the domains 110, 120, and 130. In other embodiments, the monitors 151, 152, and 153 can function in split-screen mode, wherein the “desktop” of one of the domains 110, 120, and 130 is displayed across all of the monitors 151, 152, and 153. In an exemplary embodiment, the first monitor 151 can be associated with and display information from the first domain 120. Similarly, the second monitor 152 can be associated with and display information from the second domain 130. Further, the third monitor 153 can be associated with and display information from the third domain 140. In a contemplated embodiment, when the unsecure domain 140 is activated, the first and second monitors 151 and 153 can be deactivated so that no information from the first and second domain 120 and 130 is displayed. The monitor array 150 can comprise fewer or more monitors depending upon the user preference for the particular application.

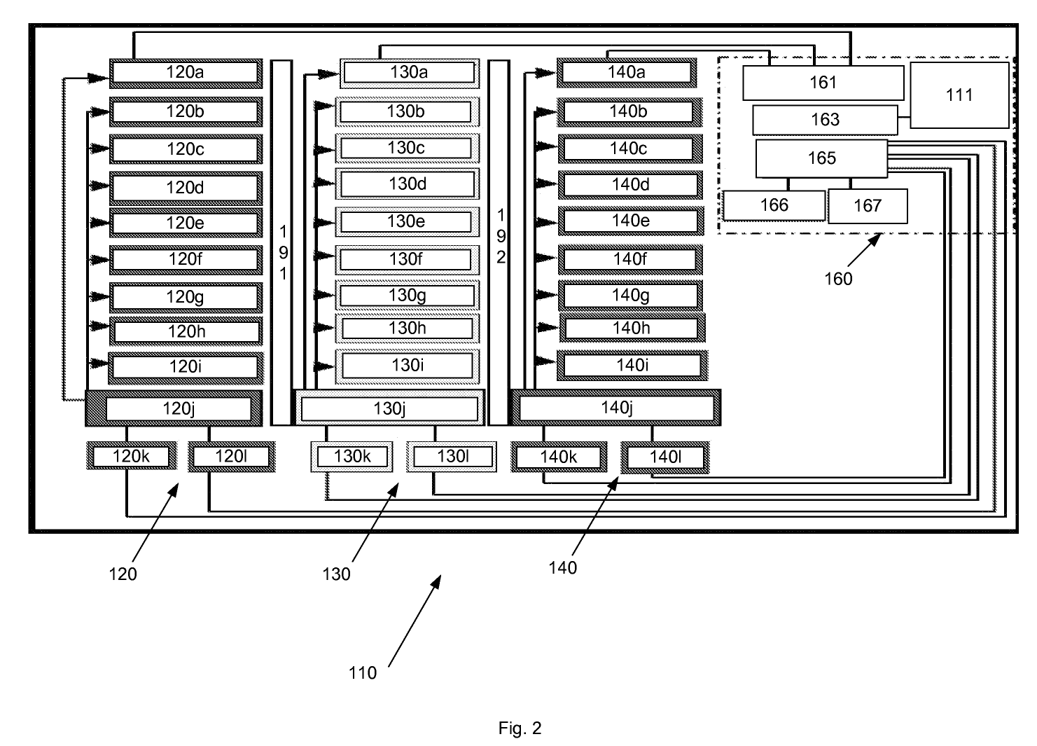

FIG. 2 illustrates a block diagram of a processing unit 110. Domains 120, 130, and 140 can include, but are not limited to, computing hardware and electronics necessary for executing an operating system. Domain 120 can include a power supply 120a, CPU 120b, memory 120c, hard drive & CD/DVD combo 120d, sound card 120e, network card 120f, video card 120g, I/O ports 120h, SmartCard drive 120i, motherboard 120j, mouse port 120k, and keyboard port 120l. Similarly, domain 130 can include a power supply 130a, CPU 130b, memory 130c, hard drive & CD/DVD combo 130d, sound card 130e, network card 130f, video card 130g, I/O ports 130h, SmartCard drive 130i, motherboard 130j, mouse port 130k, and keyboard port 130l. Further, domain 140 can include a power supply 140a, CPU 140b, memory 140c, hard drive & CD/DVD combo 140d, sound card 140e, network card 140f, video card 140g, 1/0 ports 140h, SmartCard drive 140i, motherboard 140j, mouse port 140k, and keyboard port 140l.

The electronic components of domains 120, 130, and 140 are preferably miniaturized to reduce power consumption. In an exemplary embodiment, the shape and footprint can be customized to accommodate miniaturized components. The total power consumption of the processing unit 110 is preferably less than 150 Watts. The power consumption of each of the domains 120, 130, and 140 is preferably less than 50 Watts. In a preferred embodiment, the total consumption of the processing unit is less than 105 Watts, and the total power consumption of each of the domains 120, 130, and 140 is less than 35 Watts.

The unsecured domain 140 can include a modem or network adapter for access to the internet. Each hardware domain 120, 130, and 140 can be re-booted and restarted independently without affecting the other domains, during software installations. For example, a user can quickly switch from secure domain 130 to unsecure domain 140 by toggling a domain selector switch 162 and back to secure domain 130 without shutting down and restarting either domain.

The domains 120, 130, and 140 are preferably separated and compartmentalizes within the case 111 by means of a plurality of EMF shields. In and exemplary embodiment, the first domain 120 and second domain 130 can be separated by a first shield 191, and the second domain 230 and third domain 140 can be separated by a second shield 192.

The processing unit 110 can further include a shared domain 160. The shared domain 160 can comprise components and interfaces employed by any of domains 120, 130, and 140 when activated. The shared domain can include a power key lock 161, a keyboard/mouse domain selection switch (“KM switch”) 165, a case 111, a keyboard 166, a mouse 167, and a cover alarm 163.

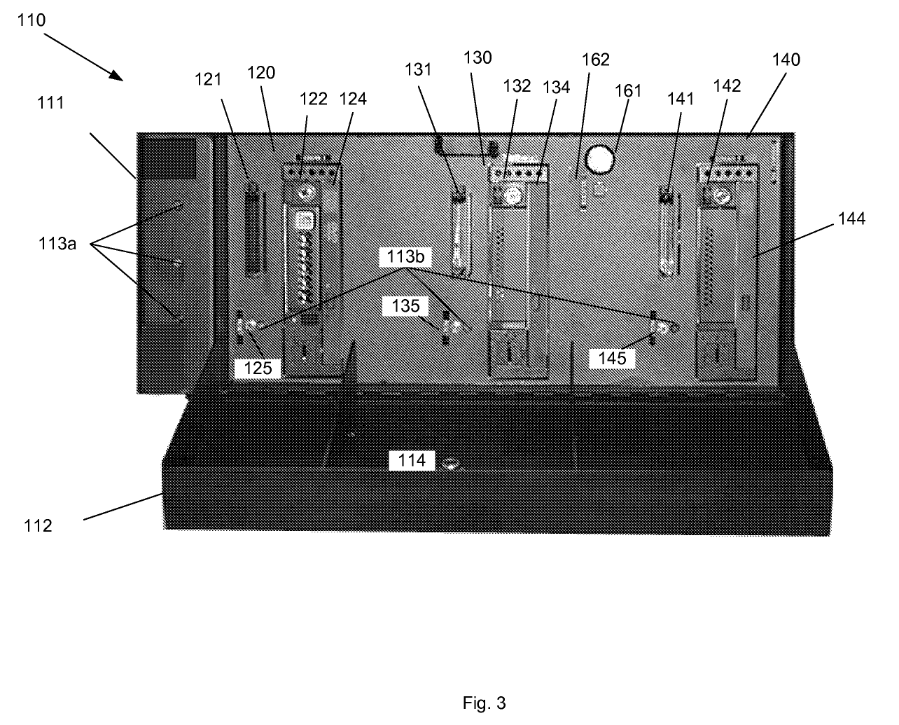

FIG. 3 illustrates a front view of the processing unit 110. The processing unit 110 can be housed within a case 111 as described above. The case 111 can comprise a front cover 112 that can be opened to provide access to domains 120, 130, and 140. The front cover 112 can comprise a lock 114 to limit physical access to the domains 120, 130, and 140. The exterior of the case 111 can include a first set of active domain light emitting diodes (LEDs) 113a corresponding to domains 120, 130, and 140, indicating which of the domains 120, 130, and 140 are currently active. Each domain 120, 130, and 140 can comprise a second set of active domain LEDs 113b, indicating which of the domains 120, 130, and 140 are currently active. The second set of LEDs 113b are not visible when the cover 112 is closed.

Domains 120, 130, and 140 each can include card combo drives 121, 131, and 141. The combo drives 121, 131, and 141 can be FORTEZZA, SmartCard, PCMCIA slot or drive. The SmartCard can be connected only on the secured hardware domain which provides access to authorized users only. In an exemplary embodiments, the processing unit 110 can employ an Athena Single Card Reader Version 1.01 and a standard ISO7816 SmartCard reader. The processing unit 110 can provide only the security hardware, allowing a user, such as a government agency, to select the desired authentication software.

The domains 120, 130, and 140 can each comprise removable hard drives 122, 132, and 142. The removable secure hard drives 122, 132, and 142 can have built-in key/locks to allow removal for safe storage when the processing unit 110 is not in use. The domains 120, 130, and 140 can include CD/DVD combo drives 124, 134, and 144. The domains 120, 130, and 140 can each include reset buttons 125, 135, and 145. A user can independently reset any of the domains 120, 130, and 140 using the reset buttons 125, 135, and 145.

The processing unit 110 can further comprise a domain selector switch 162. The domain selector switch 162 can allow a user to toggle between domains 120, 130, and 140. The switch 162 can be mechanical, electrical, or electromechanical. Alternatively or in addition to the switch 162, the keyboard can contain “hot keys” for switching between domains, for example pressing Scroll/Lock and numeric key 1, 2, or 3 can toggle between the domains 120, 130, and 140. In further embodiments, the system 100 can include a KM switch, which can be located on the front of the processing unit 110. The KM switch can toggle which of domains 120, 130, and 140 the keyboard and mouse are associated with.

The processing unit 110 can further comprise a power key lock 161. The power key lock 161 is preferably electromechanical. The user may turn on or off one or more of the domains 120, 130, and 140 using power key lock 161. The power key lock 161 can turn on or off all of the domains 120, 130, and 140 at once, or it can affect only the domain selected by the selector switch 162. Preferably the power key lock 161 is similar to the ignition key lock of a vehicle, i.e., a user must insert and preferably turn a key to turn the power on. Similarly, reverse turning and removing the key can turn the power off. The power key lock 161 may be configured to require that the key remain in the lock during operation of the processing unit 110.

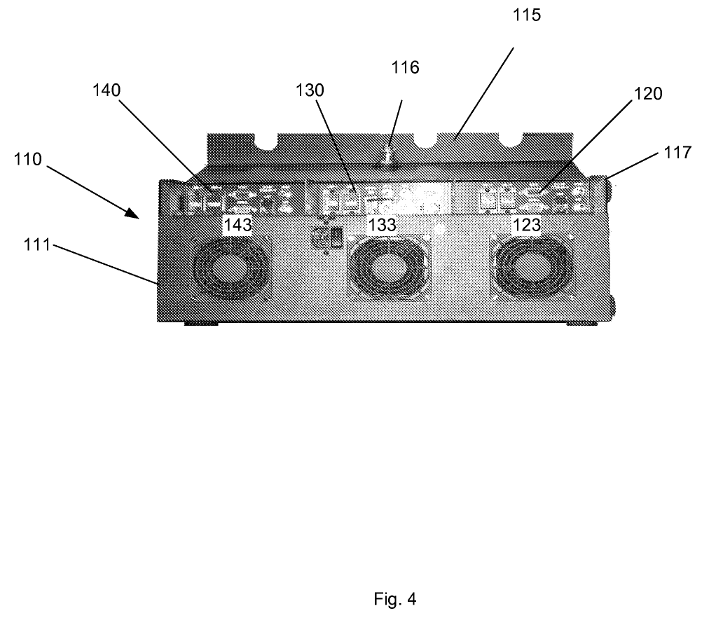

FIG. 4 illustrates a back view of a processing unit. As discussed above, the processing unit 110 in housed within a case 111. The back side of the case 111 can comprise a back cover 115. The back cover 115 can include a back cover lock for securely closing the back cover 115.

The domains 120, 130, and 140 preferably include port panels 123, 133, and 143 located on the back side of the processing unit 110. The back cover 115 can provide access to the port panels 123, 133, and 143 when the lock 116 is unlocked and the cover 115 is opened.

The port panels 123, 133, and 143 each preferably include a plurality of ports. The ports can include: video outputs; video inputs; USB ports; keyboard and mouse ports; serial ports, network ports; and other suitable ports for interfacing with devices or the processing unit 110. The back cover 115 can include apertures, indentations, or slits to accommodate cables coupled to any of the ports of port panels 123, 133, and 143. This enables the back cover 115 to be closed and locked while various cable remain securely coupled to port panels 123, 133, and 143. Cables preferably cannot be attached to or detached from port panels 123, 133, and 143 when the cover 115 is closed and locked. The back cover 115 prevents unauthorized users from manipulating network cables between the secured and unsecured domains as well as preventing removal of other devices such as video/keyboard/mouse cables.

The back of the case 111 can further include vents for the fans of each of the domains 120, 130, and 140. Further, the case can include a power plug receptacle for accepting an external power supply and a power switch. Additionally, the case 111 can include an alarm switch 117.

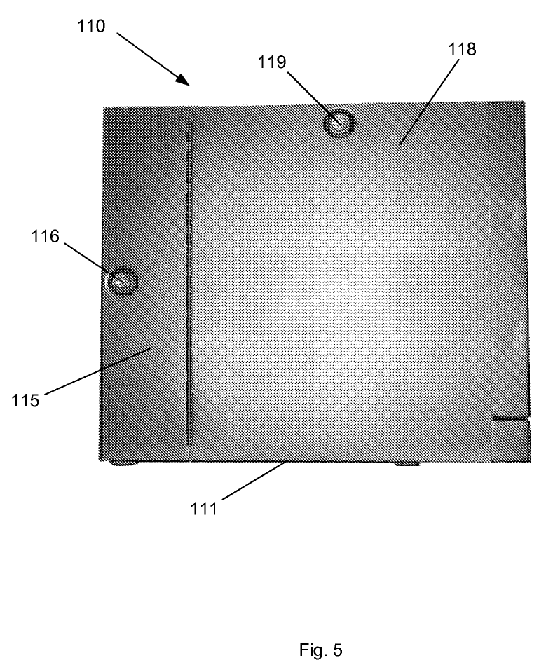

FIG. 5 illustrates a top view of the processing unit 110. The case 111 can comprise a top portion that includes a top cover 118. The top cover can include a top cover lock 119. The top cover lock 119 is preferably mechanical. Unlocking the top cover lock 119 enables opening the top cover 118, allowing access to the components of the processing unit 110, such as the mother boards, memory, video cards, etc. of the domains 120, 130, and 140. Access to the key for the top cover lock can be restricted to only authorized users.

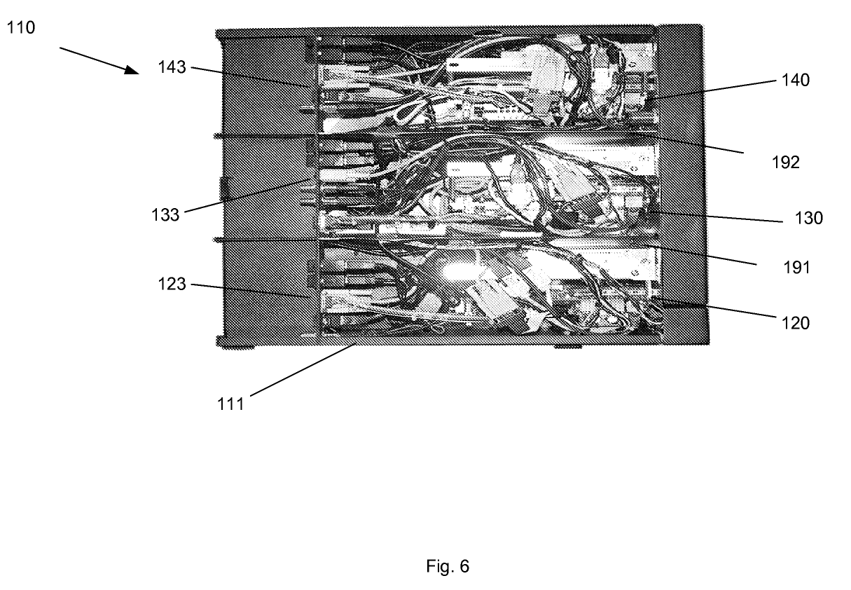

FIG. 6 illustrate a top view of the processing unit 110 with the top cover 118 removed. The domains 120, 130, and 140 are disposed within the case 111 and are separated by shields 191 and 192. Each domain 120, 130, and 140 comprises the electronic processing components discussed above. The domains 120, 130, and 140 preferably include port panels 123, 133, and 143 located on the back side of the processing unit 110 enabling interface with the components of the domains.

Implementing a physical hardware access control of the specially constructed computer case 111 itself via a hardware lock/key cover for the front of the computer case as well as the back, ensures a solid access control to the physical hardware itself before the computer can be turned on power key lock 161.

The processing unit 110 is first accessed by inserting a physical key into the mechanical key lock 114 on the front cover 112, which can be mounted on the case using a tamper-proof metal hinge. Upon opening the front cover 112 of the case 111 and powering-on the processing unit 110 using the power key lock 161, domains 120, 130, and 140 become active and access to the unsecured domain 140 can be available by default. The unsecured domain 140 can be defined by its own memory device or hard drive for storing data which by definition is a domain level with unrestricted access. The first domain level with unrestricted access may further have a modem device for telecommunication and internet access as well as a network card for unsecured network access. The unsecured domain 140 also has its own independent read-only memory device such as CD-ROM and a floppy disk drive preferably labeled with a green dot for easy identification.

Access to the secured domains 120 and 130 can be restricted by the Smart Card. An authorized user must enter a personal ID card into the Smart Card to be allowed access to the secured domains 120 and 130. Once a PIN number is entered and validated, the user can proceed and access the secured domains 120 and 130 or a classified network. When an authorized user wishes to switch to the unsecured domain 140, he or she may do so by selecting the desired domain using the domain selection switch 162 to instantly access the unsecured domain 140 without having to shut down the secured domain and re-boot the unsecured domain. The authorized user can switch back to the secure domain by pressing the secured button on the domain selection switch 162 within less than a second without re-powering or re-booting domains and without a loss of data on either domains.

The secured domains 120 and 130 are also defined by their own memory device and a removable hard drive case with a lock key, for storing data, which by definition is a domain level with restricted access. The secured domains 120 and 130 can also have their own independent read-only memory device such as compact disk CD-ROM and a floppy disk labeled with a red dot for easy identification. When the secured domain authorized user completes his or her assignment, they can then perform normal system shutdown and remove the secured domain's hard drive without affecting the operation of the unsecured domain.

In order to ensure that data may not bleed-over from the unsecured domain 140 and network to the secured domain 120 and 130 and network within the case, the motherboards and network devices can be placed approximately three or more inches apart and can separated with a special microwave aluminum shield. Such a shield can assure that the integrity of data access control, data storage, and data communications for both the secure and unsecured domain of the processing unit 110 will remain in tact emphasizing that top level security will be maintained for classified network activities.

In an exemplary embodiment, the security features of the system 100 include access control, identification, authentication, and switching mechanisms that are entirely hardware based. Access control can require a key administrator with access key #1 to unlock the front cover 112 and a user with access key #2 to turn on the system by inserting the key #2 into the power key lock 161. The key administrator can also use access key #1 to unlock the back and top cover locks, allowing access to the cable connections and back panel ports 123, 133, and 143 of the case 11 in order to maintain network cables and other hardware connections. Authorized users with possession of access key #3 can unlock and remove the removable hard drive from domains 120, 130, and 140.

Once the key administrator unlocks the front cover 112 with key #1 and the user turns on the computer with key #2, the user can then operate the default unsecured domain 140. To access the classified secure domains 120 and 130, the user must initiate identification and authentication access control by inserting a Smart Card into the appropriate drive 121 and 131. After the Smart Card has been authenticated, the user must enter a valid PIN number issued by the key administrator before being allowed to access secure domains 120 and 130.

Once access is granted, all data stored on the hard drives of secured domains 120 and 130 drive data can be encrypted/decrypted through an FIPS 140-2 certified cryptographic card. Each cryptographic card can be uniquely serial numbered to each processing unit 110. Upon shutdown the user can use access key #3 to remove the hard drives 121 and 131 to store them in a secure location.

When only the unsecured domain 140 is accessed, the user is limited to information within this domain. Consequently, the monitors 150 can only display information from the unsecured domain 140. When one of the secured domains 120 and 130 is accessed, the user can access information with the secured domain and the unsecured domain. Therefore, the monitors 150 can display information from the secured domain and the unsecured domain 150. For example, if a secured domain is accessed, the monitors can display the desktop of the secured domain and the unsecured domain.

The case 111 can have a top cover alarm 163 that can sound in the event of an unauthorized top cover 118 removal. The key administrator can turn the cover alarm 163 off by inserting key #2 into the alarm switch 117 located at the rear of the case 111.

As indicated above, an exemplary embodiment of the system 100 comprises a processing unit 110 with three compartmentalized and independent hardware-based domains, each with a dedicated power supply. In particular, these domains can be first and second secure domains 120 and 130, and a third unsecure domain 130. Accessing these three from the initial boot is described below.

Accessing First or Second Secure Domains
Key Administrator unlocks the front panel with access key #1.
Trusted User Access through the use of access key #2 (SECURE domain booted but not accessible).
Trusted User Identification and Authentication Access through the use of a Smart Card. Successful authentication return from the Smart Card reader (through a correct pin). The Smart Card needs to remain in the Smart Card reader during the SECURE domain session. If the Smart Card is removed, the trusted user is automatically logged off.
Access is now available to the SECURE domain and network.
The trusted user can shut down the system and remove the encrypted SECURE Hard Drive by using access key #3 to unlock the SECURE Hard Drive tray.

Accessing Third Unsecure Domain
Key Administrator unlocks the front panel with access key #1.
User Access through the use of access key #2 (SECURE domain(s) booted but not accessible).
Successful Authentication through OS user name and password
Access is now available to the UNSECURE domain and network.

An exemplary embodiment of the processing unit can comprise the following components: SSI case; Domain selector switch 4 port; SSI power pack; Processor/CPU—Intel Pentium IV×3; Motherboard—Industrial P4×3; Chipset—Intel 440BX; BIOS: 2 MB AMI Flash BIOS and APM 1.2, DMI 2.1, Plug and Play; Memory—1 GB DDR 333×3; Video—(64 MB) Intel (build-in); Hard Drives: 80.0 GB ATA 3.5″ (removable, Unsecured domain), 80.0 GB ATA 2.5″ (removable, first secure domain), 80.0 GB ATA 2.5″ (removable, second secure domain), 3.5-inch removable SECURE hard drive case×3, CD-ROM: CD-ROM drive×2 (slim, first and second secure domains); DVD/CDRW drive×1 (slim, unsecured domain); Network Interface Card (NIC)—Intel×3; Keyboard—STC E05300; Mouse or Trackball; Monitor—LCD×3; Sound Card—Creative SB16; Speakers—Mli-699; tamper-proof case; SmartCard identification and authentication drive×2 (3d optional); operating system—Windows XP Pro; keys #1, 2, 3 (one set).

All of the keys used in the system 100 are preferably illegal to duplicate and clearly identified on the face of each key as being illegal to duplicate. Additionally, each key is preferably unique to the corresponding lock such that no two systems can be accessed the same key. In another contemplated embodiment, a single key may be employed per processing unit 110 that can access all of the locks associated with the case 111 and processing unit 110.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all applicable equivalents.

I claim:

1. A multi-domain computer comprising:
a first computer domain comprising a first motherboard, a first processor, a first data storage device, a first power supply, and a first dedicated bus;
an second computer domain comprising a second motherboard, a second processor, a second data storage device, a second power supply, and a second dedicated bus;
a third computer domain comprising a third motherboard, a third processor, a third removable data storage device, a third power supply, and a third dedicated bus;
the first computer domain, the second computer domain and the third computer domain isolated so that no information is shared between any of the first computer domain, the second computer domain and the third computer domain, and the first computer domain adapted to remain operable when the third removable data storage device is removed from the third computer domain; and
a computer enclosure for housing the first computer domain, the second computer domain and the third computer domain, the computer enclosure having a plurality of access covers including a front cover and a back cover for providing access to at least a portion of the interior of the computer enclosure and a front cover lock for preventing unauthorized access to the computer enclosure through the front cover; and a back cover lock for preventing unauthorized access to the computer enclosure through the back panel.

2. The multi-domain computer of claim 1, further comprising:
a first electromagnetic field shield located inside the computer enclosure between the first computer domain and the second computer domain to prevent data migration between the first computer domain and the second computer domain.

3. The multi-domain computer of claim 2, wherein the first electromagnetic field shield is fabricated of an aluminum alloy with a copper EMF shield sprayed thereon.

4. The multi-domain computer of claim 2, further comprising a second electromagnetic field shield located inside the computer enclosure between the second computer domain and the third computer domain to prevent data migration between the second computer domain and the third computer domain.

5. The multi-domain computer of claim 1, further comprising:
one or more user data input devices;
a user data input selector switch for alternatively coupling the one or more user data input devices to the first computer domain, the second computer domain, and the third computer domain without rebooting any of the first computer domain, the second computer domain, or the third computer domain; and
wherein the first computer domain, the second computer domain, and the third computer domain are adapted to be operational at the same time.

6. The multi-domain computer of claim 5, wherein the one or more user interface devices comprise a keyboard and a mouse.

7. The multi-domain computer of claim 1, wherein at least one of the second computer domain and the third computer domain is a secure computer domain and the multi-domain computer further comprising:
a smart card access controller for authenticating users prior to allowing access to the secure computer domain.

8. The multi-domain computer of claim 7, wherein the first domain may be accessed by a user without smart card authentication.

9. The multi-domain computer of claim 1, further comprising:
a key-lock power switch having an associated key for powering on the first computer domain, the second computer domain, and the third computer domain.

10. The multi-domain computer of claim 1, further comprising:
a first reset button for resetting the first computer domain without resetting the second computer domain or the third computer domain;
a second reset button for resetting the second computer domain without resetting the first computer domain or the third computer domain; and
a third reset button for resetting the third computer domain without resetting the first computer domain or the second computer domain.

11. The multi-domain computer of claim 1, wherein the total power consumption of the first computer domain, the second computer domain, and the third computer domain are no more than 150 watts.

12. The multi-domain computer of claim 1, wherein the total power consumption of the first computer domain, the second computer domain, and the third computer domain are no more than 105 watts.

13. The multi-domain computer of claim 11, wherein the total power consumption of the first computer domain is no more than 50 watts.

14. The multi-domain computer of claim 12, wherein the total power consumption of the first computer domain is no more than 35 watts.

15. The multi-domain computer of claim 1, further comprising a top panel lock for controlling access to internal components of the computer through a top panel.

16. The multi-domain computer of claim 1, further comprising:
a first video monitor associated with the first computer domain;
a second video monitor associated with the second computer domain; and
a third video monitor associated with the third computer domain.

17. The multi-domain computer of claim 1, the first video monitor adapted to display information from the first computer domain, the second video monitor adapted to display information from the second computer domain, the third video monitor adapted to display information from the third video domain, wherein the first, second, and third video monitors are adapted to simultaneously display information.

18. The multi-domain computer of claims 1, the computer enclosure adapted to mount to a standardized 19-inch rack.
